(19) United States
(12) Patent Application Publication
(10) Pub. No.: US 2011/0003235 A1
(43) Pub. Date: Jan. 6, 2011

(54) SOLID OXIDE FUEL CELL AND MANUFACTURING METHOD THEREOF

(75) Inventors: CHANG-SING HWANG, Taoyuan County (TW); Chun-Huang Tsai, Taoyuan County (TW); Nian-Tzu Suen, Taoyuan County (TW); Jen-Feng Yu, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/781,376

(22) Filed: May 17, 2010

(30) Foreign Application Priority Data
Jul. 3, 2009 (TW) 098122508

(51) Int. Cl. H01M 8/10; H01M 8/00

(52) U.S. Cl. 429/495; 427/446; 216/37; 427/456; 429/535

(57) ABSTRACT

A solid oxide fuel cell comprising a metal frame, a porous metal substrate, a first anode isolation layer, an anode interlayer, a second anode isolation layer, an electrolyte layer, a cathode isolation layer, a cathode interlayer and a cathode current collecting layer. The first anode isolation layer, the anode interlayer, the second anode isolation layer, the electrolyte layer, the cathode isolation layer, the cathode interlayer and the cathode current collecting layer are sequentially disposed on the porous metal substrate. The first anode isolation layer is porous sub-micron structured or porous micron structured; the anode interlayer is porous nano structured; the second anode isolation layer is dense structured or porous nano structured; the electrolyte is dense and gas-tight; the cathode isolation layer is dense structured or porous nano structured; the cathode interlayer is porous nano structured or porous sub-micron structured; and the cathode current collecting layer is porous micron structured.

### BACKGROUND OF THE INVENTION

1. Field of the Invention

The present invention generally relates to a solid oxide fuel cell and a manufacturing method thereof and, more particularly, to a solid oxide fuel cell comprising a nano structured electrode with a metal support operating at intermediate temperature and a manufacturing method thereof.

2. Description of the Prior Art

The solid oxide fuel cell (SOFC) is an electrochemical power generation device, in which oxygen (or air) and hydrogen are used for power generation so as to achieve high power generation efficiency with low pollution. There are numerous reports on the electrolyte, the anode and the cathode of an solid oxide fuel cell, such as Appleby, “Fuel cell technology: Status and future prospects,” Energy, 21, 521, 1996; Singhal, “Science and technology of solid-oxide fuel cells,” MRS Bulletin, 25, 16, 2000; Williams, “Status of solid oxide fuel cell development and commercialization in the U.S.,” Proceedings of 6th International Symposium on Solid Oxide Fuel Cells (SOFC VI), Honolulu, Hi., 3, 1999; and Hujismans et al., “Intermediate temperature SOFC- a promise for the 21th century,” J. Power Sources, 71, 107, 1998). Generally, the electrolyte is made of yttria-stabilized zirconia (YSZ), the anode is made of a cermet (Ni/YSZ) composed of nickel and yttria-stabilized zirconia (YSZ), and the cathode is made of conductive lanthanum strontium-doped manganite (LSM, LaMnO₃) with a perovskite structure.

However, since yttria-stabilized zirconia (YSZ) exhibits sufficient ion conductivity only at high temperatures within a range from 900 to 1000° C., the solid oxide fuel cell made of high-cost materials is thus not widely used.

Therefore, in the prior art, a thinner yttria-stabilized zirconia (YSZ) electrolyte layer (about 5 μM) is provided to reduce the resistance and loss under the working temperature lower than 900° C. Alternatively, an electrolyte (made of, for example, lanthanum strontium gallate magnesite (LaGaO₃), LSGM) with high ion conductivity can be used to manufacture a solid oxide fuel cell that works at intermediate temperature (600 to 800° C.) with lower manufacturing cost. As the working temperature is reduced, the reliability and duration of the solid oxide fuel cell can be improved so that it is helpful to make the solid oxide fuel cell more acceptably used in home and car applications.

However, when the working temperature of the solid oxide fuel cell is lowered to about 600° C., a thinner yttria-stabilized zirconia (YSZ) electrolyte layer (about 5 μM) will not have enough ion conductivity to satisfy the low resistance loss requirement. Therefore, other electrolyte materials such as gadolinium doped ceria (GDC) or lanthanum strontium gallate magnesite (LSGM) with high ion conductivity are required.

Moreover, as the temperature decreases, electrochemical activities at the cathode and anode decrease, and polarization resistances at the cathode and anode increase with a larger energy loss. Therefore, new materials for the cathode (such as lanthanum strontium cobalt ferrite (LSCF, La_{0.6}Sr_{0.4}Co_{0.2}Fe_{0.8}O₃)) and the anode (such as a mixture (GDC/Ni) composed of nickel and gadolinium doped ceria (GDC) or a mixture (LDC/Ni) composed of nickel and lanthanum doped ceria (LDC)) are required. Moreover, in the prior art, the cathode and the anode are mostly micron-structured, which should be improved to be nano structured so as to increase the number of tri-phase boundaries (TPB) to improve the electrochemical activities at the cathode and the anode to reduce energy loss.

For the anode structure, in Virkar' s “Low-temperature anode-supported high power density solid oxide fuel cells with nano structured electrodes,” Fuel Cell Annual Report, 111, 2003, a Ni/YSZ cermet as the anode of a solid oxide fuel cell is disclosed with a thin layer of smaller pores and a thick layer of larger pores. The diameters of the smaller pores should be as small as possible to increase the number of tri-phase boundaries (TPB). However, Virkar fails to disclose how to manufacture the thin layer with nano structure in that report.

Moreover, Wang also discloses, in “Influence of size of NiO on the electrochemical properties for SOFC anode,” Chemical Journal of Chinese Universities, a mixture of nano NiO and micron YSZ is press-formed and reduced by hydrogen to obtain a cermet anode with increased tri-phase boundaries (TPB) and reduced electrode energy loss. However, Wang also fails to disclose how to make a nano-structured anode in that paper.

For the cathode structure, in Liu's “Nano structured and functionally graded cathodes for intermediate temperature solid oxide fuel cells,” J. Power Sources, 138, 194, 2004, a nano and functionally graded structured cathode is manufactured by combustion chemical vapor-phase deposition. (TPB) at the cathode is increased, the polarization and ohmic resistances are lowered to reduce the energy loss.

For the electrolyte, as the electrolyte thickness increases, the internal resistance of the solid oxide fuel cell increases to cause larger energy loss and smaller output power. More particularly, when the working temperature of the solid oxide fuel cell is below 700° C., the energy loss due to electrolyte resistance becomes dominant. Therefore, the electrolyte thickness has to be reduced or the ion conductivity in the electrolyte has to be enhanced so as to improve the output power delivered by the cell.

Generally, the solid oxide fuel cell can be manufactured by (1) chemical vapor-phase deposition (CVD) (2) electrochemical vapor-phase deposition (3) sol-gel (4) strip casting (5) silk screen printing (6) physical vapor-phase deposition (7) spin coating and (8) plasma spray. There are two methods to perform plasma spray: atmospheric plasma spray and vacuum plasma spray. The atmospheric plasma spray does not need vacuum equipment and process, it has the cost advantage, comparing with vacuum plasma spray. In the above manufacturing methods, strip casting, silk screen printing and spin coating require plural high-temperature sintering processes, while chemical vapor-phase deposition (CVD), electrochemical vapor-phase deposition, sol-gel, physical vapor-phase deposition and plasma spray can be used to manufacture the solid oxide fuel cell without high-temperature sintering processes.

In the manufacturing methods requiring high-temperature sintering processes, it often leads to warping and cracks in the components of the solid oxide fuel cell during high-temperature sintering.

Moreover, high-temperature sintering is often used to obtain the dense electrolyte layer and improve the contact between the electrolyte layer and the electrode layer, but it also causes the porous electrode layer to become denser and less mass transfer. Moreover, high-temperature sintering process often results in chemical reactions between the electrolyte layer and the electrode layer, those reactions are often unfavorable to the cell performances and occur. For example, the lanthanum strontium gallate magnesite (LSGM) electrolyte layer reacts at high temperatures with nickel in the anode interlayer to produce an insulating lanthanum nickel oxide (LaNiO₃) layer and to increase the internal resistance of the solid oxide fuel cell. (See Zhang et al., “Interface reactions in the NiO-SDC-LSGM system,” Solid State Ionics, 139, 145, 2001).

U.S. Patent Appl. No. 2007/0009784 discloses an intermediate temperature solid oxide fuel cell manufactured by high-temperature sintering. The anode is formed of a mixture (LDC/Ni) composed of nickel and lanthanum doped ceria (LDC, La_{0.4}Ce_{0.6}O₂); the electrolyte is formed of lanthanum strontium gallate magnesite (LSGM); and the cathode is formed of an interlayer comprised of lanthanum strontium gallate magnesite (LSGM) and lanthanum strontium cobalt ferrite (LSCF) with 50%:50% volumetric ratio and a current collecting layer comprised of lanthanum strontium cobalt ferrite (LSCF).

In order to prevent lanthanum strontium gallate magnesite (LSGM) electrolyte from reacting with nickel particles in the anode interlayer to produce insulating lanthanum nickel oxide (LaNiO₃) at high temperatures such as 1200 to 1300° C. for sintering anode and 1100° C. for sintering cathode, an isolation layer (for example, the second anode isolation layer in FIG. 1) formed of lanthanum doped ceria (LDC) is added between the anode and the electrolyte.

However, when the thickness of lanthanum strontium gallate magnesite (LSGM) electrolyte is smaller than 20 μm, cobalt (Co) particles in lanthanum strontium cobalt ferrite (LSCF) cathode diffuse into the lanthanum strontium gallate magnesite (LSGM) electrolyte at high temperatures to worsen the electron insulation of this electrolyte and cause electron transport and internal leakage in the solid oxide fuel cell. As a result, the open-circuit voltage is smaller than 1 volt. In other words, it is inevitable that the manufacturing methods requiring high-temperature sintering are problematic of element diffusions and reactions at high temperatures.

Among the manufacturing methods without high-temperature sintering, the atmospheric plasma spray is very potential and has attracted lots of attention. More particularly, the plasma flame of atmospheric plasma spray is capable of heating up the injected powders to be melted or semi-melted. The melted or semi-melted powders are cooled down and turned into a film instantly after they bombard the substrate. In this method, chemical reactions (for example, to produce insulating lanthanum nickel oxide (LaNiO₃)) that are unfavorable to the cell performances can be avoided, as disclosed in Hui et al., “Thermal plasma spraying for SOFCs: Applications, potential advantages, and challenges,” J. Power Sources, 170, 308, 2007.

Moreover, U.S. Patent Appl. No. 2004/0018409 discloses a solid oxide fuel cell manufactured by dual-gas atmospheric plasma spray with low voltage (lower than 70V) and high current (larger than 700 A). In this patent, when the thickness of the lanthanum strontium gallate magnesite (LSGM) electrolyte is larger than 60 μm, the open-circuit voltage (OCV) is larger than 1V. Since the plasma arc root at the anode nozzle of plasma spray gun moves with the plasma gas stream to cause voltage variation ΔV of the plasma spray gun. Therefore, the atmospheric plasma spray with a gun that works at low voltage and large current exhibits a relatively large voltage variation ratio ΔV/V, which leads to an unstable powder heating and an unreliable coating.

Moreover, in the low-voltage high-current dual-gas atmospheric plasma spray, the shorter plasma arc leads to a shorter heating time and a poorer thermal heating efficiency of powders. Moreover, the high current results in the serious erosions of cathode and anode electrodes of atmospheric plasma spray gun. The cathode and the anode are updated more frequently and the cost of manufacturing solid oxide fuel cells increases.

In U.S. Patent Appl. No. 2004/0018409, the micron powder clusters for plasma spray are formed by aggregating powders smaller than 100 nm with a polyvinyl alcohol (PVA) binder. The PVA binder is then removed by conventional heating processes to acquire sintered porous nano structured micron powder clusters. These nano structured micron powder clusters formed by complicated processes in this patent increase the cost of manufacturing the solid oxide fuel cell. Moreover, to increase the surfaces of these micron powder clusters for heating by plasma flame, these powder clusters are often formed in a hollow structure that costs more.

### SUMMARY OF THE INVENTION

It is an object of the present invention to provide a solid oxide fuel cell with excellent electric characteristics, the high thermal conductivity by using a metal support and the excellent long-term durability.

It is another object of the present invention to provide a manufacturing method of a solid oxide fuel cell using tri-gas (argon, helium and hydrogen) atmospheric plasma spray with medium current and high voltage of spray gun to spray powder clusters divided into groups according to the size to improve thin film quality and efficiency.

In the present invention, the powder clusters are divided into groups according to the size. For example, a group for size within a range from 10 to 20 μm, a group for size within a range from 20 to 40 μm and a group for size within a range from 40 to 70 μm are provided. Since only one group of powder clusters is sprayed by the plasma spray gun at a time, the power value for such a group of powder clusters is selected. For example, powder clusters of 10 to 20 μm are sprayed with a power value of 46 to 49 kW when a LSGM electrolyte layer is manufactured. Moreover, powder clusters of 20 to 40 μm are sprayed with a power value of 49 to 52 kW, while powder clusters of 40 to 70 μm are sprayed with a power value of 52 to 55 kW. Therefore, the present invention prevents the large powder clusters from being unevenly heated or being difficult to become semi-melted and the smaller powder clusters from being decomposed due to overheating. The above-mentioned powder cluster sizes and plasma spray power values are only exemplary and do not limit the scope of the present invention.

In order to achieve the foregoing or other objects, the present invention provides a solid oxide fuel cell comprising a metal frame, a porous metal substrate, a first anode isolation layer, an anode interlayer, a second anode isolation layer, an electrolyte layer, a cathode isolation layer, a cathode interlayer and a cathode current collecting layer.

The porous metal substrate is treated with powdering, hot-pressing and acid etching so as to form a high mechanical strength and high gas permeability porous metal substrate. As this porous metal substrate is disposed on a solid metal frame and welded together, the mechanical strength is increased further.

The first anode isolation layer is porous sub-micron or micron structured. The anode interlayer is porous nano structured. The second anode isolation layer is dense structured or porous nano structured. The electrolyte layer is dense and gas-tight. The cathode isolation layer is dense structured or porous nano structured. The cathode interlayer is porous nano structured or porous sub-micron structured. The cathode current collecting layer is porous micron structured.

The first anode isolation layer is disposed on the porous metal substrate. The anode interlayer is disposed on first anode isolation layer. The second anode isolation layer is disposed on anode interlayer. The electrolyte layer is disposed on second anode isolation layer. The cathode isolation layer is disposed on electrolyte layer. The cathode interlayer is disposed on cathode isolation layer. The cathode current collecting layer is disposed on cathode interlayer.

The first anode isolation layer may be a single-layered structure formed of LDC or lanthanum strontium manganese chromite (La_{0.75}Sr_{0.25}Cr_{0.5}Mn_{0.5}O₃, LSCM) or a double-layered structure formed of LDC and LSCM or chromic oxide. LSCM has the capability to prohibit the elements interdiffusion between the anode interlayer and the porous metal substrate. LSCM has also the capability to act as an anode material for converting not only pure hydrogen fuels but also the hydrocarbon fuels into electricity (Sun et al., “Recent anode advances in solid oxide fuel cells” J. Power Sources, 171, 247, 2007). The thickness of the first anode isolation layer is preferably 10 to 20 μm and the porosity thereof is preferably 15 to 30%. However, the present invention is not limited thereto.

The second anode isolation layer may be a single-layered structure formed of LDC. The thickness of the second anode isolation layer is preferably 5 to 15 μm. However, the present invention is not limited thereto.

The anode interlayer may be a uniformly mixed structure formed of LDC and nickel or a uniformly mixed structure formed of LDC and copper, or a uniformly mixed structure formed of other anode materials.

The electrolyte layer may be a single-layered structure formed of LSGM or a double-layered structure formed of LDC and LSGM.

The cathode isolation layer may be a single-layered structure formed of LDC. Moreover, the present can do without the cathode isolation layer so that the cathode interlayer is disposed on the electrolyte layer.

The cathode interlayer may be a uniformly mixed structure formed of LSGM and LSCF or a single-layered structure formed of LSCF.

The cathode current collecting layer is disposed on cathode interlayer. The cathode current collecting layer may be a single-layered structure formed of LSCF.

After all the layers are deposited and the post treatment is performed, the porous metal substrate is disposed on metal frame. The isolation layers have capabilities to prohibit diffusion of poison elements.

In the present invention, the supporting structure of the solid oxide fuel cell is composed of a porous metal substrate and a metal frame so as to increase resistance to cell deformation at high temperatures, cell flatness, cell mechanical strength, supporting strength for cell stack manufacture and thermal conductivity of cell and stack. Moreover, the anode interlayer and the cathode interlayer of the solid oxide fuel cell are formed of a nano structure comprising nano particles. Therefore, the electrochemical reaction activities and conductivities of anode and cathode electrodes can be improved with lowered electrode resistances to reduce power consumption. Moreover, the lifetime of the cell's electrode structure is lengthened because the internal temperature of electrode is minimized by the less internal heating of electrode resistance.

To overcome the short lifetime problem of spray gun electrodes operated at low voltage (under 70V) and high current (over 700 A) in the conventional dual-gas atmospheric plasma spray process, the present invention provides a medium current and high voltage tri-gas atmospheric plasma spray process and a method of dividing the powder clusters into groups so as to exhibits a long plasma arc to increase the heating time of injected powders and enable the powders to be heated efficiently at high voltage (higher than 107V) and medium current (under 510 A). Since the working current is smaller, the erosion rates and lifetimes of the cathode and anode of plasma spray gun can be lengthened to reduce cost.

Moreover, in the present invention, nano-structured micron powder clusters formed by aggregating nano powders with diameters smaller than 100 nm with a polyvinyl alcohol (PVA) binder and micron powder clusters formed by aggregating sub-micron powders and micron powders with a polyvinyl alcohol (PVA) binder are divided into groups according to the cluster size. One of the groups of powder clusters for forming a desired layer is injected into the plasma flame of medium current and high voltage tri-gas atmospheric plasma spray (APS). The plasma flame removes the polyvinyl alcohol (PVA) binder and heats up the remained nano, sub-micron and micron powders.

In the plasma flame, since nano powders exhibit a larger surface area, it helps the nano powders to be heated up uniformly to be melted or semi-melted. The manufactured nano-structured layer does not only provide better functionality due to the nano structure, but also reduce the amount of powders for atmospheric plasma spray and thus the cost for manufacturing the solid oxide fuel cell can be also reduced.

When plasma spray is used to form porous nano or sub-micron or micron structured layers by nano or sub-micron or micron powders, lower power plasma spray is used. Since the size of injected micron powder clusters has been selected to fall within a narrower range, the micron powder clusters are uniformly heated to be semi-melted due to approximately identical size (mass) to be deposited as a large-area porous layer with uniform pores after they are injected into the plasma flame. Meanwhile, the nano powders exhibit a larger surface area can be more uniformly heated to deposit as a porous nano structured layer.

When plasma spray is used to manufacture a dense and gas-tight electrolyte layer, higher power plasma spray is used. Since the size of injected micron powder clusters has been selected to fall within a narrower range, the micron powder clusters are uniformly heated to be semi-melted due to approximately identical size (mass) to be deposited as a large-area dense and gas-tight electrolyte layer after they are injected into the plasma flame.

Therefore, a high power solid oxide fuel cell can be formed by manufacturing the porous layers and the dense gas-tight layers. Moreover, atmospheric plasma spray is a rapid sintering process, in which the average surface temperatures of coated substrates are kept at temperatures lower than 1000° C. and the temperatures of post heat treatment after the spray coating are also performed at temperatures lower than 1000° C., hence the problems such as the chemical reaction of lanthanum strontium gallate magnesite (LSGM) with nickel and the cobalt diffusion into lanthanum strontium gallate magnesite (LSGM) electrolyte that occur in the conventional high-temperature sintering process can be avoided.

Moreover, in present invention, nano powders and nano pores refer to powders and pores smaller than 100 nm; sub-micron powders and sub-micron pores refer to powders and pores smaller between 100 nm to 500 nm; and micron powders and micron pores refer to powders and pores between 1 to 100 μm.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a cross-sectional view of a solid oxide fuel cell according to a first embodiment of the present invention;

FIG. 2A and FIG. 2B show a comparison of film formation by atmospheric plasma spray in the present invention and in the prior art;

FIG. 3 is a flowchart of a manufacturing method of a solid oxide fuel cell according to the first embodiment of the present invention;

FIG. 4 is a flowchart of a preliminary treatment on the porous metal substrate in the manufacturing method of a solid oxide fuel cell according to the first embodiment of the present invention;

FIG. 5A to FIG. 5D are schematic diagrams of powder injection according to the first embodiment of the present invention;

FIG. 6A and FIG. 6B show the power performance and the long-term durability test at a constant 400 mA/cm² of a solid oxide fuel cell according to the first embodiment of the present invention; and

FIG. 7 is a cross-sectional view of a solid oxide fuel cell according to a second embodiment of the present invention.

### DETAILED DESCRIPTION OF THE PREFERRED EMBODIMENT

The present invention can be exemplified but not limited by the embodiments as described hereinafter.

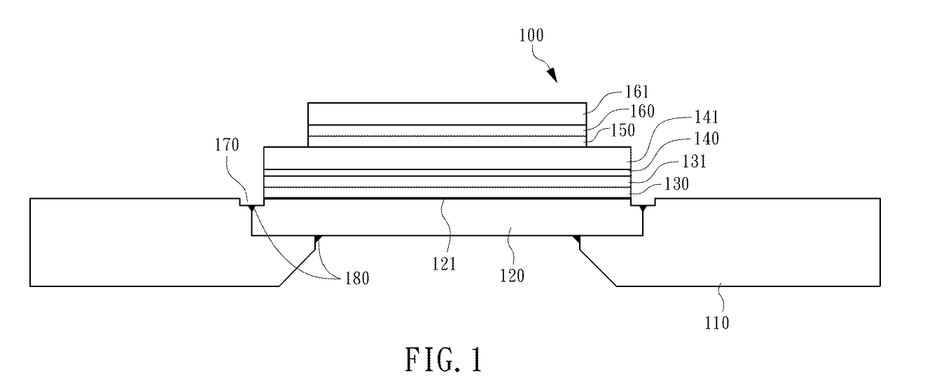

FIG. 1 is a cross-sectional view of a solid oxide fuel cell according to a first embodiment of the present invention. Referring to FIG. 1, the solid oxide fuel cell 100 in the present invention comprises a metal frame 110, a porous metal substrate 120, a first anode isolation layer 130, an anode interlayer 131, a second anode isolation layer 140, an electrolyte layer 141, a cathode isolation layer 150, a cathode interlayer 160 and a cathode current collecting layer 161.

On the porous metal substrate 120, the first anode isolation layer 130, the anode interlayer 131, the second anode isolation layer 140, the electrolyte layer 141, the cathode isolation layer 150, the cathode interlayer 160 and the cathode current collecting layer 161 are formed in order. Then, the porous metal substrate 120 is welded to the metal frame 110. Moreover, and the anode interlayer 131 can be porous nano-structured, and the cathode interlayer 160 can be porous nano-structured or porous sub-micron structured.

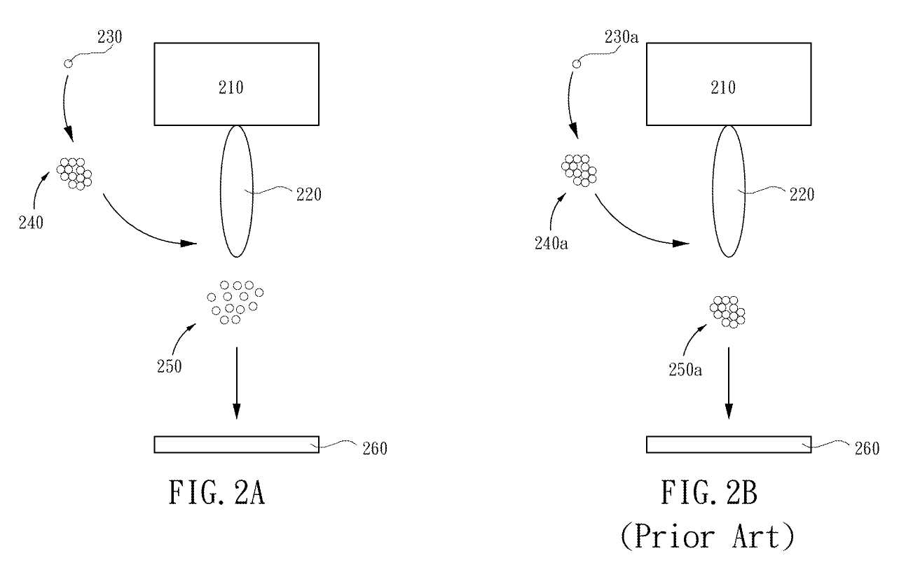

Please refer to FIG. 2A and FIG. 2B for a comparison of film formation by the medium current and high voltage tri-gas atmospheric plasma spray in the present invention and in the prior art (U.S. Patent Appl. No. 2004/0018409), respectively. A plasma spray gun 210 generates a plasma flame 220 to deposit powder clusters 240/240a onto a substrate 260 to form a thin film.

In FIG. 2A, nano powders 230 are aggregated by a polyvinyl alcohol (PVA) binder to form nano-structured micron powder clusters, while sub-micron powders or micron powders 230 are aggregated by a polyvinyl alcohol (PVA) binder to form submicron-structured or micron-structured micron powder clusters. These powder clusters are divided in groups of micron powder clusters 240, for example, a group of micron powder clusters between 10 to 20 μm, a group of micron powder clusters between 20 to 40 μm and a group of micron powder clusters between 40 to 70 μm. One selected group of micron powder clusters is then injected into the plasma flame 220 generated by the medium current and high voltage tri-gas atmospheric plasma spray (APS) operating at determined power to remove the polyvinyl alcohol (PVA) binder by the plasma flame 220 and heat up the unbound powders 250 which may be nano powders or sub-micron powders or micron powders.

As the polyvinyl alcohol (PVA) binder is removed by the plasma flame 220, the unbound powders 250 exhibit a larger distance between powders due to the removal of the PVA binder. As a result, the unbound powders 250 will have a larger surface area as a whole so that the plasma flame 220 can uniformly heat up the unbound powders 250 to be melted or semi-melted. Considering manufacturing porous layers, the unbound powders 250 are uniformly semi-melted to form a nano structured layer with uniform nano pores if the unbound powders 250 are nano powders, to form a sub-micron structured layer with uniform sub-micron pores if the unbound powders 250 are sub-micron powders, or form a micron structured layer with uniform micron pores if the unbound powders 250 are micron powders. Considering manufacturing a dense and gas-tight layer, the unbound powders 250 are uniformly melted to form a large-area dense and gas-tight layer with few closed pores. The manufactured nano, sub-micron or micron structured porous layer provides better functionality due to the structure with higher gas permeability, more tri-phase boundaries (TPB) and higher conductivity.

However, in FIG. 2B, in the prior art (U.S. Patent Appl. No. 20040018409), nano powders 230a with diameters smaller than 100 nm are added to a polyvinyl alcohol (PVA) binder to form nano-structured micron powder clusters 240. The powder clusters 240 are then heated up by the conventional thermal process to remove the PVA binder to form sintered porous nano-structured micron powder clusters 240a. Then, the powder clusters 240a injected into a plasma flame 220 generated by the conventional atmospheric plasma spray (APS) are heated up into melted or semi-melted nano powder clusters 250a to form a thin film on the substrate 260.

Since the nano-structured micron powder clusters 240a have experienced the conventional thermal process, the nano powder clusters 240a and 250a are aggregated so tightly to decrease the surface area of powders to be heated by plasma flame 220. Therefore, the plasma flame 220 is not able to uniformly and efficiently heat up the nano powder clusters 240a and 250a. As a result, the thin film as formed exhibits poor quality. Moreover, since the powder clusters 240a are not divided and selected before being injected into the plasma flame, the non-uniform size of powder clusters 240a results in poor quality due to non-uniform heating. Moreover, in the prior art, the conventional thermal process used to remove the PVA binder results in increased manufacturing cost.

In the present invention, the powder clusters can be formed by agglomeration using the PVA binder or by sintering and crushing. The powder clusters formed by sintering and crushing can also be divided into groups of powder clusters of 10 to 20 μm, 20 to 40 μm and 40 to 70 μm. The present invention is not limited to the number of groups and the size of the powder clusters.

Moreover, compared to conventional dual-gas atmospheric plasma spray (U.S. Patent Appl. No. 20040018409), the plasma flame generated by the medium current and high voltage tri-gas atmospheric plasma spray in the present invention exhibits a longer plasma arc and then the longer plasma flame to lengthen the time for heating powders so that the powders are heated up more efficiently to be deposited to form a thin film with better quality. More particularly, the thin film as formed exhibits more tri-phase boundaries (TPB) and stronger mechanical strength.

In the present embodiment, the anode interlayer 131 comprises a uniform mixture of electron-conducting nano particles and oxygen-negative-ion-conducting nano particles. The electron-conducting nano particles comprise nickel, copper, nickel-copper or nickel-copper-cobalt. The oxygen-negative-ion-conducting nano particles comprise yttria-stabilized zirconia (YSZ), lanthanum doped ceria (LDC) or gadolinium doped ceria (GDC). In other words, the anode interlayer 131 comprises a uniform mixture (YSZ/Ni) of nickel and yttria-stabilized zirconia (YSZ), a uniform mixture (LDC/Ni) of nickel and lanthanum doped ceria (LDC) or a uniform mixture (GDC/Ni) of nickel and gadolinium doped ceria (GDC).

As stated above, the anode interlayer 131 exhibits a plurality of nano tri-phase boundaries (TPB) composed of three nano structures. The first is nano pores; the second is yttria-stabilized zirconia (YSZ) powders, lanthanum doped ceria (LDC) powders, gadolinium doped ceria (GDC) powders or other oxygen-negative-ion-conducting nano powders; and the third is nickel (Ni) powders, copper (Cu), nickel-copper (Ni/Cu), nickel-copper-cobalt (Ni/Cu/Co) or other electron-conducting nano powders. These nano tri-phase boundaries (TPB) can effectively enhance the electrochemical reaction activity and conductivity of the anode interlayer 131 and reduce the resistance of the anode interlayer 131 and hence the energy loss. Moreover, due to the uniform intermixing of nano metal particles with nano ceramic particles, the problem of nano metal particle or nano ceramic particle aggregation at high temperatures can be avoided so as to lengthen the lifetime of the anode interlayer 131.

In the present embodiment, the cathode interlayer 160 is a uniformly mixed single-layered structure, for example, a uniformly mixed structure composed of lanthanum strontium gallate magnesite and lanthanum strontium cobalt ferrite (LSGM/LSCF), a uniformly mixed structure composed of gadolinium doped ceria and lanthanum strontium cobalt ferrite (GDC/LSCF) or a uniformly mixed structure composed of lanthanum doped ceria and lanthanum strontium cobalt ferrite (LDC/LSCF). Similarly, the cathode interlayer 160 exhibits excellent electrochemical reaction activity and conductivity due to the nano tri-phase boundaries (TPB). Alternatively, the cathode interlayer 160 can also be a single-layered structure comprising only one cathode material, for example, LSCF. If the cathode interlayer 160 is a uniformly mixed single-layered structure, it can be formed by uniformly mixing LSGM (the same as the electrolyte layer 141) and LSCF with a volume ratio of 50%:50%.

In the anode interlayer 131 and the cathode interlayer 160, the thickness of the anode interlayer 131 is within a range from 10 to 30 μm, preferably within a range from 15 to 25 μm. The porosity of the anode interlayer 131 is within a range from 15 to 30%. The thickness of the cathode interlayer 160 is within a range from 15 to 40 μm, preferably within a range from 20 to 30 μm. The porosity of the cathode interlayer 160 is within a range from 15 to 30%. The anode interlayer 131 and the cathode interlayer 160 can be gradedly structured to eliminate the effect of differences of their thermal expansion coefficients. For example, in the LSGM/LSCF cathode, one can gradually increase the percentage occupied by LSCF along the direction to the LSCF current collector 161.

Referring to FIG. 1, the porous metal substrate 120 of the present invention allows the reactive gas to pass through. However, such a porous structure weakens the mechanical strength of the porous metal substrate 120. Therefore, in the present invention, a metal frame 110 is provided to support the porous metal substrate 120 and enhance the structural strength of the solid oxide fuel cell 100.

In the present embodiment, the porous metal substrate 120 comprises a porous metal sheet comprising nickel, iron, copper or a mixture of them. More particularly, the porous metal sheet comprises nickel powders, nickel powders mixed with iron powders, copper powders mixed with iron powders or copper powders and nickel powders mixed with iron powders. The weight percentage of the iron powders is not more than 50%. Moreover, the porosity of the porous metal substrate 120 is enhanced by acid etching to fall within a range from 35 to 55% with gas permeability coefficient enhanced to fall within a range from 2 to 6 Darcy. The thickness of the porous metal substrate 120 is within a range from 1 to 2 mm, and the area of the porous metal substrate 120 is within a range from 2.5×2.5 cm² to 20×20 cm², to which the present invention is not limited.

Moreover, the first anode isolation layer 130 and anode interlayer 131 are sequentially deposited on the porous metal substrate 120. When the diameters of the surface pores on the porous metal substrate 120 are larger than 50 μm, it is difficult to deposit the anode isolation layer 130 and the anode interlayer 131 without large pinhole defects. Therefore, in the present invention, a porous sintered thin powder layer 121 is applied on the porous metal substrate 120 so that the diameters of the surface pores on the porous metal substrate 120 are smaller than 50 μm. The methods to apply a porous sintered thin powder layer 121 on the porous metal substrate 120 may be screen printing and sintering or other wet powder coating techniques. The porous sintered thin powder layer 121 comprises nickel, iron, copper or a mixture of them. In the case of nickel and iron mixture for forming the porous sintered thin powder layer 121, the weight percentage of the iron powders is not more than 50%.

The metal frame 110 comprises anti-oxidation and anti-corrosion stainless steel such as ferritic stainless steel, or other metal materials with high temperature resistance, anti-oxidation and anti-corrosion such as commercial products Crofer22 and ZMG232. The thickness of the metal frame 110 is with a range from 2 to 3 mm and the thermal expansion coefficient of the metal frame 110 is within a range from 10 to 14×10⁻⁶/° C., so as to match the thermal expansion coefficient of electrolyte layer 141.

It is noted that even though the metal frame 110 of the present embodiment does not directly contact the cathode interlayer 160 and the cathode current collecting layer 161, a protection layer (not shown) can be coated on the metal frame 110 to prevent chromium pollution on the cathode interlayer 160 and cathode current collecting layer 161. The protection layer comprises manganese-cobalt spinel or lanthanum strontium-doped manganite (LSM).

In the present embodiment, the metal frame 110 and the porous metal substrate 120 are connected by laser welding with welding points 180 labeled by small points in FIG. 1. However, the present invention is not limited to how the porous metal substrate 120 and the metal frame 110 are connected. Because of the high integrity, high resistance to deformation, high mechanical strength of the solid oxide fuel cell 100 and the high alignment capability of the metal frame 110, a plurality of solid oxide fuel cells 100 can be stacked as a cell stack. Moreover, a groove 170 can be provided at the joint of the metal frame 110 and the porous metal substrate 120 to be filled with a sealant.

Referring to FIG. 1, the electrolyte layer 141 can be single-layered, double-layered or multi-layered. A single-layered electrolyte layer 141 may comprise lanthanum strontium gallate magnesite (LSGM), lanthanum doped ceria (LDC) or gadolinium doped ceria (GDC). A double-layered electrolyte layer 141 may comprise negative-oxygen-ion-conducting materials such as lanthanum doped ceria-lanthanum strontium gallate magnesite (LDC-LS GM) or gadolinium doped ceria-lanthanum strontium gallate magnesite (GDC-LSGM). A tri-layered or multi-layered electrolyte layer 141 may comprise lanthanum doped ceria-lanthanum strontium gallate magnesite-lanthanum doped ceria (LDC-LSGM-LDC) or lanthanum doped ceria-lanthanum strontium gallate magnesite-gadolinium doped ceria (LDC-LSGM-GDC). As stated above, the order and thickness of these layers can be decided according to practical use. In the present embodiment, the thicknesses of lanthanum doped ceria (LDC) and gadolinium doped ceria (GDC) are within a range from 10 to 20 μm, and the thickness of lanthanum strontium gallate magnesite (LSGM) is within a range from 30 to 45 μm.

It is noted that, when the solid oxide fuel cell 100 operates at high temperatures below 700° C., present invention can do without the second anode isolation layer 140 and the cathode isolation layer 150. On the contrary, the second anode isolation layer 140 can be disposed between the anode interlayer 131 and the electrolyte layer 141 or the cathode isolation layer 150 can be disposed between the cathode interlayer 160 and the electrolyte layer 141 when the solid oxide fuel cell 100 operates at high temperatures higher than 700° C. In other words, the isolation layer comprises materials that do not react with adjacent materials and are oxygen-negative-ion-conducting, such as lanthanum doped ceria (LDC), yttria doped ceria (YDC) or gadolinium doped ceria (GDC).

Referring to FIG. 1, the cathode current collecting layer 161 is for collecting the current from the cathode interlayer 160. Relatively, the porous metal substrate 120 is for collecting the current from the anode. The cathode current collecting layer 161 can be sub-micron or micron structured and comprises sub-micron or micron lanthanum strontium cobalt ferrite (LSCF) powders, sub-micron or micron lanthanum srtrontium cobaltite (LSCo) powders, sub-micron or micron lanthanum strontium ferrite (LSF) powders or samarium strontium cobalt oxide (SSC) powders. In the present embodiment, the thickness of the cathode current collecting layer 161 is within a range from 20 to 50 μm, preferably within a range from 30 to 40 μm. The porosity of the cathode current collecting layer 161 is within a range from 30 to 50%. Moreover, the cathode current collecting layer 161 may comprise an electron-ion mixed conducting material. However, the present invention is not limited to the material, the powder sizes, the thickness or the porosity of the cathode current collecting layer 161.

It is noted that the present invention is not limited to whether the cathode current collecting layer 161 is porous sub-micron or micron structured. For example, nano catalysis metal can be impregnated into the porous sub-micron or micron structured cathode current collecting layer 161 using impregnation and percolation so as to turn the porous sub-micron or micron structured in the cathode current collecting layer 161 into porous and nano-structured. The nano catalysis metal can be nano silver, nano palladium or other that can increase the capability of adsorbing oxygen molecules and dissociating them into oxygen atoms.

The structure of the solid oxide fuel cell 100 of the present invention has been described in detail. The manufacturing method of the solid oxide fuel cell 100 will be described with reference to the flowcharts in accompanying drawings, especially for the medium current and high voltage tri-gas (using argon, helium and hydrogen) atmospheric plasma spraying process according to the present invention.

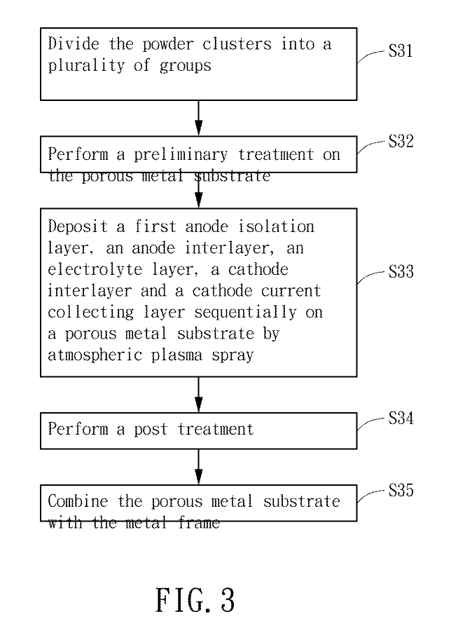

FIG. 3 is the flowchart of a manufacturing method of a solid oxide fuel cell according to the first embodiment of the present invention. Referring to FIG. 3, the manufacturing method of a solid oxide fuel cell 100 according to the present invention comprises steps S31 to S35.

First, in the step S31, the powder clusters are divided into a plurality of groups. For example, a group for size within a range from 10 to 20 μm, a group for size within a range from 20 to 40 μm and a group for size within a range from 40 to 70 μm are provided.

In step S32, a preliminary treatment is performed on a porous metal substrate 120.

Then, in step S33, a first anode isolation layer 130, an anode interlayer 131, a second anode isolation layer 140, an electrolyte layer 141, a cathode isolation layer 150, a cathode interlayer 160 and a cathode current collecting layer 161 are formed in order on the porous metal substrate 120 (as shown in FIG. 1). At least one of the layers is formed by the medium current and high voltage tri-gas atmospheric plasma spray process using argon, helium and hydrogen as the plasma gas. In the description herein, all the layers of the solid oxide fuel cell 100 in the present invention are manufactured by the medium current and high voltage tri-gas atmospheric plasma spray process.

For better quality, after the cathode current collecting layer 161 is formed, a post treatment in step S34 is performed in the present embodiment. The post treatment is performed to improve the performances and reliability of the solid oxide fuel cell 100.

It is noted that the present invention is not limited to the order for performing step S31 and step S32. In other words, step S32 can be performed prior to performing step S31.

After the pre-treated porous metal substrate 120 has been coated with all the layers, step 35 is performed to combine the porous metal substrate 120 and metal frame 110. Alternatively, the porous metal substrate 120 and metal frame 110 can be combined prior to depositing all the layers on the porous metal substrate 120. The present invention is not limited to the sequence for performing the steps. The porous metal substrate 120 and metal frame 110 can be combined by welding. However, the present invention is not limited thereto.

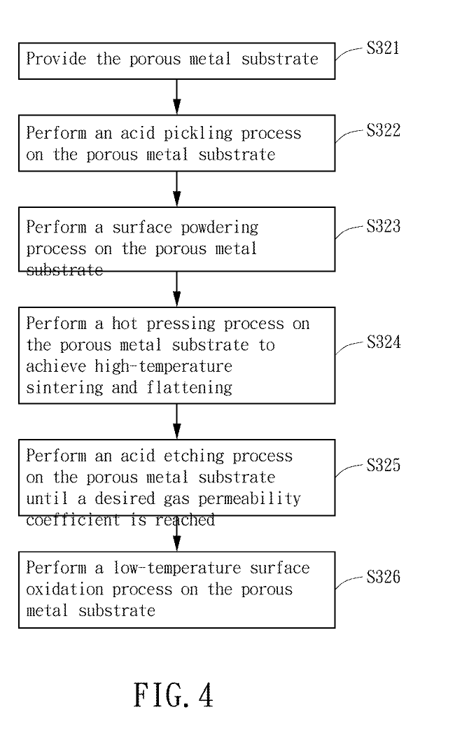

The porous metal substrate preliminary treatment process will be described in detail hereinafter. FIG. 4 is a flowchart of a preliminary treatment according to the first embodiment of the present invention. Referring to FIG. 4, in steps S321, a porous metal substrate 120 is provided.

In step S322, an acid pickling process is performed on the porous metal substrate 120. In other words, the porous metal substrate 120 is dipped in a diluted nitric acid and/or hydrochloric acid solution for 10 to 60 minutes. More particularly, the acid solution is implemented by adding 50 mL nitric acid to 1000-mL de-ionized water.

In step S323, a surface powdering process is performed on the porous metal substrate 120. The surface powdering process comprises two sub-steps. Firstly, high metal-containing slurry is deposited on the boundary of porous metal substrate 120 so as to form a frame (with a width of 1 to 5 mm in the present embodiment). Secondly, metal powders are deposited inside the frame and are then flattened. The slurry and the metal powders are used to match with the porous metal substrate 120. For example, the metal powders comprise nickel powders or a mixture of nickel, iron, copper and cobalt. If the porous metal substrate 120 comprises nickel, the slurry comprises nickel and the metal powders comprise nickel powders for surface powdering. Preferably, the particle size in the nickel slurry is smaller than 10 μm and the particle size in the nickel powders is with a range from 30 to 50 μm. In the case that the porous metal substrate 120 and metal frame 110 is combined by welding, this frame is used to take the advantage for welding, but the first sub-step can be omitted if the welding is not difficult.

Then in step S324, a hot pressing process is performed on the porous metal substrate to achieve high-temperature sintering and flattening The hot pressing process is to perform hot pressing at a temperature below 1100° C. in a vacuum or a reducing atmosphere and under a pressure below 50 kg/cm² for 1 to 3 hours and then cool down to room temperature. As a result, a porous sintered thin powder layer 121 enclosed by a dense frame with a width of 1 to 5 mm can be formed on the porous metal substrate 120. The diameters of the surface pores of this porous layer 121 is helpful for later filming processing, while the dense frame is helpful for welding the porous metal substrate 120 and the metal frame 110.

Then, in step S325, an acid etching process is performed on the porous metal substrate 120 with the porous sintered thin powder layer 121. In other words, the porous metal substrate 120 with the porous sintered thin powder layer 121 is dipped in a diluted nitric acid and/or hydrochloric acid solution for 30 to 90 minutes until a desired gas permeability coefficient is reached, for example, 2 to 6 Darcy. The diameter of the pores is less than 50 μm after the porous sintered thin powder layer 121 is etched.

In some cases, an acid etching process of step S325 is performed on the porous metal substrate 120 to increase the permeability first, and then perform the step S323 and step S324 on the etched porous metal substrate 120 later. Therefore our invention is not limited to the sequence of steps S323, S324 and S325. In some cases, the steps S323, S324 and S325 may be iterated several times, therefore our invention is not limited to the iterated times of steps S323, S324 and S325.

Finally, in step S326, a low-temperature surface oxidation process is performed on the porous metal substrate at 600 to 700° C. for 20 to 50 minutes in an atmospheric environment so that the diameter of the pores on the porous sintered thin powder layer 121 is further reduced.

As stated above, the thickness of the porous metal substrate 120 is within a range from 1 to 2 mm and the area thereof is within a range from 5 cm×5 cm to 20 cm×20 cm. However, the present invention is not limited to the material, structure or shape of the porous metal substrate 120.

Referring to FIG. 3, the first anode isolation layer 130, the anode interlayer 131, the second anode isolation layer 140, the electrolyte layer 141, the cathode isolation layer 150, the cathode interlayer 160 and the cathode current collecting layer 161 can be formed by a medium current and high voltage tri-gas atmospheric plasma spray process disclosed in the present invention. It is noted that any of the foregoing layers can be formed by the tri-gas atmospheric plasma spray process to improve the performance of the solid oxide fuel cell 100. In one preferred embodiment of the present invention, all the foregoing layers are formed by the medium current and high voltage tri-gas atmospheric plasma spray process, to which the present invention is not limited.

The plasma flame by the medium current and high voltage tri-gas atmospheric plasma spray process in the present invention exhibits a longer plasma arc to lengthen the time for heating the powder clusters by the high-temperature plasma flame so that the powders are heated up more efficiently to be deposited to form a thin film with better quality. Moreover, the tri-gas atmospheric plasma spray process is performed in a medium current and high voltage environment. Since the working current is smaller, the electrode erosion of atmospheric plasma spray gun is reduced and the lifetime of the atmospheric plasma spray gun can be lengthened to reduce cost.

More particularly, the medium current and high voltage tri-gas atmospheric plasma spray process is a reliable high-voltage, high-enthalpy atmospheric plasma spray process using a mixture of argon, helium and hydrogen to produce an atmospheric plasma flame with high enthalpy. In the mixture of argon, helium and hydrogen of one present embodiment, the flow rate of argon is within a range from 49 to 60 slpm, the flow rate of helium is within a range from 23 to 27 slpm, and the flow rate of hydrogen is within a range from 2 to 10 slpm, but the present invention is not limited to the ranges of flow rates.

Moreover, the working voltage of the medium current and high voltage tri-gas atmospheric plasma spray process can be adjusted according to the material to be sprayed. When a dense layer such as the electrolyte 141 is to be formed, parameters for larger power and working voltage larger than 100±1 volt can be used. When a porous electrode layer such as the anode interlayer 131 or the cathode interlayer 160 is to be formed, parameters for smaller power and working voltage about 86±1 volt can be used. In other words, the reliable medium current, high voltage and high-enthalpy tri-gas atmospheric plasma spray process of the present invention is capable of adjusting spray parameters according to the practical need to form any of the layers of the solid oxide fuel cell 100 easily and rapidly. Anyone with ordinary skill in the art can make modifications on the embodiments within the scope of the present invention.

Similarly, in the present invention, the powder clusters can be formed by using a polyvinyl alcohol (PVA) binder or by sintering and crushing the sintered materials. In the present embodiment, nano, sub-micron or micron structured powder clusters are formed by adding powders to a polyvinyl alcohol (PVA) binder and injecting the powder and the PVA binder together into a plasma flame to remove the binder and heat up the remained powders to be melted or semi-melted for film formation. These nano-structured micron powder clusters are applied to form the anode interlayer 131 and the cathode interlayer 160 by adding nano powders to the polyvinyl alcohol (PVA) binder.

As stated above, in the sub-micron structure or micron structured cathode current collecting layer 161, the powder clusters are formed by adding sub-micron powders or micron powders to a polyvinyl alcohol (PVA) binder. However, the present invention is not limited the material of powder clusters. For example, the powder clusters can be formed of a mixture of nano powders, sub-micron powders and micron powders added to a PVA binder. It depends on the structure of the layer. Moreover, even though the binder is formed of polyvinyl alcohol, the present invention is not limited thereto.

Most importantly, in the present invention, the powder clusters are divided into, for example, a group for size within a range from 10 to 20 μm, a group for size within a range from 20 to 40 μm and a group for size within a range from 40 to 70 μm. Since only one group of powder clusters is sprayed by the plasma spray gun at a time, the optimal power value for such a group of powder clusters is selected to heat up the selected group of powder clusters.

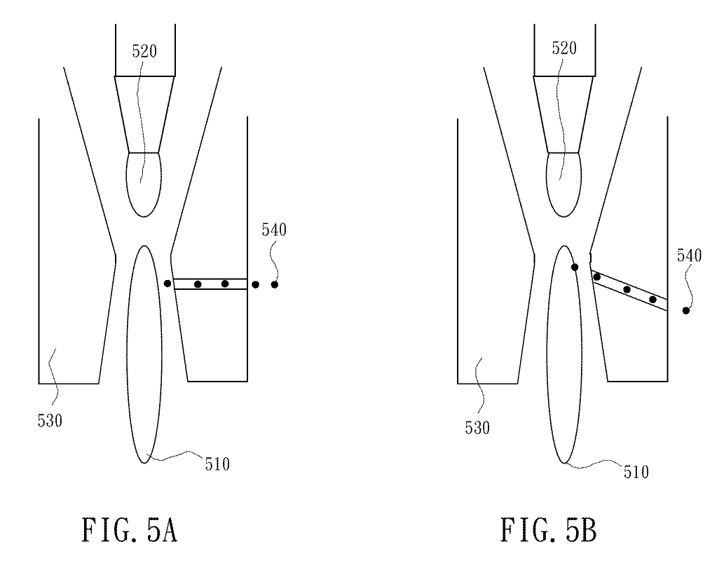

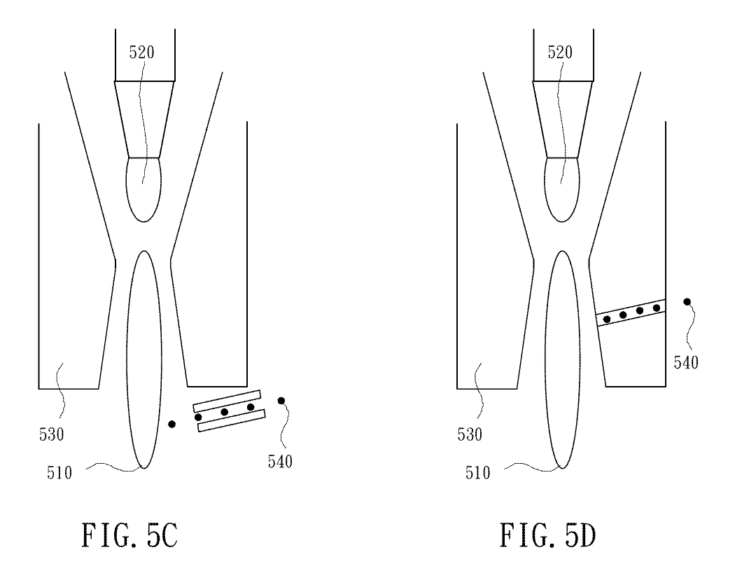

Moreover, the film characteristics vary with the ways the powder clusters are injected into the plasma flame. FIG. 5A to FIG. 5D are schematic diagrams of powder injection according to one embodiment of the present invention. Referring to FIG. 5A to FIG. 5D, the plasma flame 510 is generated from the cathode 520 through the anode nozzle 530. The powder clusters 540 are injected into the plasma flame 510 to deposit thin films. In FIG. 5A, the powder clusters 540 are internally injected horizontally into the plasma flame 510. In FIG. 5B, the powder clusters 540 are internally injected upward into the plasma flame 510. In FIG. 5C, the powder clusters 540 are externally injected downward into the plasma flame 510. In FIG. 5D, the powder clusters 540 are internally injected downward into the plasma flame 510. With these ways of powder injection, the powder clusters 540 are injected into the plasma flame 510 differently to obtain different film characteristics.

In the formation of the first anode isolation layer 130 and the anode interlayer 131 in the present embodiment, the porous metal substrate 120 is heated up to 650 to 750° C. before coating the anode layer 130. The medium current and high voltage tri-gas atmospheric plasma spray process is performed to inject the powder clusters internally horizontally (in FIG. 5A) or internally downward (in FIG. 5D) into the plasma flame 510 to be deposited onto the porous metal substrate 120 to form the first anode isolation layer 130 and the anode interlayer 131. Moreover, to make the first anode isolation layer 130 and the porous anode interlayer 131 and to increase the adhesion between the first anode isolation layer 130 and the porous metal substrate 120, and between the anode interlayer 131 and the first anode isolation layer 130, the powder clusters are internally injected horizontally (in FIG. 5A) or internally injected downward (in FIG. 5D) into the plasma flame 510. The material, thickness and structure of the anode interlayer 131 have been described and thus descriptions thereof are not presented herein. Moreover, to increase the porosity of the anode interlayer 131, carbon powders are added to the clusters to function as a pore-forming agent. In present embodiment, the weight percentage of carbon powders is smaller than 15 wt %, which will not affect the mechanical strength of the anode interlayer 131 too much.

In the formation of the second anode isolation layer 140 and the electrolyte layer 141 in present embodiment, the porous metal substrate 120, the first anode isolation layer 130 and the anode interlayer 131 are heated up to 750 to 900° C. The medium current, high voltage tri-gas atmospheric plasma spray process is performed to inject the powder clusters internally horizontally (in FIG. 5A) or internally upward (in FIG. 5B) into the plasma flame 510 and the heated powder clusters are deposited onto the anode interlayer 131 to form the second anode isolation layer 140 and the electrolyte layer 141 in order. Certainly, if the solid oxide fuel cell 100 is to operate below 700° C., the deposition of the second anode isolation layer 140 and the cathode isolation layer 150 can be omitted. The material, thickness and structure of the second anode isolation layer 140, the electrolyte layer 141 and the cathode isolation layer 150 have been described and thus descriptions thereof are not presented herein. Moreover, to make the powder clusters entirely melted or almost entirely melted while forming the second anode isolation layer 140 and the electrolyte layer 141, the powder clusters are internally injected upward into the plasma flame 510 as in FIG. 5B.

The second anode isolation layer 140 comprises materials that do not react with adjacent materials and are oxygen-negative-ion-conducting, such as lanthanum doped ceria (LDC), yttria doped ceria (YDC) or gadolinium doped ceria (GDC)

In the present embodiment, the cathode isolation layer 150 comprises materials that do not react with adjacent materials and are oxygen-negative-ion-conducting, such as lanthanum doped ceria (LDC), yttria doped ceria (YDC) or gadolinium doped ceria (GDC). In other words, the cathode isolation layer 150 and the second anode isolation layer 140 are used to achieve the same or similar functions. The manufacturing of the cathode isolation layer 150 is similar to that of the second anode isolation layer 140. Prior to the deposition of the cathode isolation layer 150, the substrate has to be heated up to 750 to 900° C.

In the formation of the cathode interlayer 160 and the cathode current collecting layer 161 in present embodiment, the porous metal substrate 120, the first anode isolation layer 130, the anode interlayer 131, the second anode isolation layer 140, the electrolyte layer 141 and the cathode isolation layer 150 are heated up to 650 to 750° C. The medium current, high voltage tri-gas atmospheric plasma spray process is performed to deposit the powder clusters on the cathode isolation layer 150 to form the cathode interlayer 160 and the cathode current collecting layer 161 in order. The powder clusters are externally injected downward (in FIG. 5C) into the plasma flame 510 so as to obtain the cathode interlayer 160 and the cathode current collecting layer 161 with excellent porosity. The material, thickness and structure of the cathode interlayer 160 and the cathode current collecting layer 161 have been described and thus descriptions thereof are not presented herein. Moreover, to increase the porosity of the cathode interlayer 160, carbon powders are added to the clusters to function as a pore-forming agent. In present embodiment, the weight percentage of carbon powders is smaller than 15 wt %, which will not affect the mechanical strength of the cathode interlayer 160 too much.

Referring to FIG. 3, a post treatment is performed (in step S34) after the first anode isolation layer 130, the anode interlayer 131, the second anode isolation layer 140, the electrolyte layer 141, the cathode isolation layer 150, the cathode interlayer 160 and the cathode current collecting layer 161 are formed in order so as to improve the performances of the solid oxide fuel cell 100.

In the present embodiment, the post treatment is a hot-pressing treatment at a temperature lower than 1000° C. so as to adjust the cathode resistance to a minimum value and achieve a maximum output power density of the solid oxide fuel cell 100. More particularly, the post treatment is a hot-pressing treatment at a temperature within a range from 875 to 950° C. under a pressure within a range from 200 g to 1 kg/cm². The hot-pressing treatment is to increase the cathode powder connection and is capable of reducing the cathode resistance so that the maximum output power density up to 1.2 W/cm² can be achieved.

Moreover, the objects of the hot-pressing treatment are to eliminate the stress in the layers formed by plasma spray and to increase the adhesion between these layers. The pressure and temperature of hot-pressing treatment need to be appropriate. The thermal treatment temperature is adjusted according to the plasma spray power for forming the cathode interlayer 160 and the cathode current collecting layer 161. With appropriate pressure and thermal treatment temperature, the contact areas between the powders in the cathode interlayer 160 and in the cathode current collecting layer 161 can be increased, so that the electron- and ion-conducting capability of the cathode interlayer 160 and the electron-conducting capability of the cathode current collecting layer 161 can be increased, while remaining high gas permeabilities of the cathode interlayer 160 and cathode current collecting layer 161.

The manufacturing parameters for the layers and measured characteristics of the solid oxide fuel cell 100 in the present invention are described hereinafter. It is noted that the presented results and characteristics are not presented to limit the present invention. Anyone with ordinary skill in the art can make modifications on the parameters within the scope of the present invention.

It is noted that, to improve the mechanical strength and flatness of the solid oxide fuel cell 100 under 800° C., the porous metal substrate 120 and the metal frame 110 are combined together by laser welding so as to complete the solid oxide fuel cell 100. The metal frame 110 comprises ferritic stainless steel such as Crofer22 or other metal materials with high temperature resistance for anti-oxidation and anti-corrosion. Moreover, a protection layer (not shown) can be formed on both sides of the metal frame 110 by the medium current and high voltage tri-gas atmospheric plasma spray process. The protection layer comprises, for example, manganese-cobalt spinel or lanthanum strontium-doped manganite (LSM).

The manufacturing parameters for the layers and measured characteristics of the solid oxide fuel cell 100 in the present invention are described hereinafter. The powder clusters, formed by agglomeration or sintering and crushing, are divided into groups and are then selected before being injected in to the plasma flame generated by the medium current, high voltage tri-gas atmospheric plasma spraying. Moreover, the porous metal substrate has experienced a preliminary treatment as described previously. It is noted that the presented results and characteristics are not presented to limit the present invention. Anyone with ordinary skill in the art can make modifications on the parameters within the scope of the present invention.

### Example 1: the porous first anode isolation layer comprising LSCM (La_{0.75}Sr_{0.25}Cr_{0.5}Mn_{0.5}O₃)

The powder clusters to be injected into the plasma flame are formed by sintering and crushing and are categorized into the group for cluster sizes between 40 to 70 μm. Before sintering and crushing, the sizes of original powders are within a range from 0.6 to 2 μm. These powder clusters with sizes between 40 to 70 μm are transmitted by a dual-hopper powder feeder (such as Sulzer Metco Twin-120) and are internally injected horizontally (in FIG. 5A) or internally injected downward (in FIG. 5D) into the plasma flame. The plasma spray parameters include: the plasma gas flow rate: 49 to 60 slpm for argon, 23 to 27 slpm for helium, and 7 to 9 slpm for hydrogen; the spray power: 32 to 38 kw (current: 302 to 362 A, voltage: 105 to 106V); the spray distance: 9 to 11 cm; the scanning rate of the spray gun: 500 to 700 mm/sec; the powder feeding rate: 2 to 8 g/min; and pre-heating temperature of substrate for film deposition: 650 to 750° C.

### Example 2: the porous nanostructured anode interlayer comprising a graded mixture (LDC/Ni) of nickel and lanthanum doped ceria (LDC, Ce_{0.55}La_{0.45}O₂)

The powder clusters to be injected into the plasma flame are formed by agglomeration and are categorized into the group for sizes between 20 to 40 μm. There are two types of powder clusters injected into the plasma flame. One is micron powder clusters formed of nano lanthanum doped ceria (LDC) powders and a polyvinyl alcohol (PVA) binder, while the other is micron powder clusters formed of nano nickel oxide (NiO) powders and a polyvinyl alcohol (PVA) binder. These two types of powder clusters are transmitted by a dual-hopper powder feeder (such as Sulzer Metco Twin-120) to a Y-hybrid powder mixer connected to a plasma spray gun. The powders are internally injected horizontally (FIG. 5A) or internally injected downward (FIG. 5D).

Moreover, the plasma spray parameters include: the plasma gas flow rate: 49 to 60 slpm for argon, 23 to 27 slpm for helium, and 7 to 9 slpm for hydrogen; the spray power: 36 to 42 kw (current: 340 to 400 A, voltage: 105 to 106V); the spray distance: 9 to 11 cm; the scanning rate of the spray gun: 500 to 700 mm/sec; the powder feeding rate: 2 to 8 g/min; and pre-heating temperature of substrate for film deposition: 650 to 750° C.

The anode interlayer formed of a mixture (LDC/Ni) of nano nickel and nano lanthanum doped ceria (LDC) is obtained by reducing a mixture (LDC/NiO) of nano nickel oxide and nano lanthanum doped ceria (LDC) using hydrogen.

Moreover, the anode interlayer can be gradedly coated and the ratio between nano lanthanum doped ceria (LDC) and nano nickel (Ni) changes according to the gradedly volumetric ratio along a normal direction to the surface of this anode layer. In other words, the anode layer contains a higher percentage of nano nickel (Ni) as it gets closer to the porous metal substrate. Moreover, if the anode layer is not to be formed as gradedly structured, a layer of a mixture (LDC/NiO) of nano lanthanum doped ceria (LDC) and nano nickel (Ni) with 50%:50% volumetric ratio of LDC:Ni is formed by spraying micron powder clusters comprise a mixture of nano lanthanum doped ceria (LDC) powders, nano nickel oxide (NiO) powders and a polyvinyl alcohol (PVA) binder.

### Example 3: the dense isolation layer (as the second anode isolation layer or the cathode isolation layer) comprising nano lanthanum doped ceria (LDC)

The powder clusters to be injected into the plasma flame are formed by agglomeration and are categorized into the group for sizes between 20 to 40 μm. The powder clusters are micron powder clusters formed of nano lanthanum doped ceria (LDC) powders and a polyvinyl alcohol (PVA) binder. The powders are internally injected upward (FIG. 5B). The plasma spray parameters include: the plasma gas flow rate: 49 to 60 slpm for argon, 23 to 27 slpm for helium, and 7 to 9 slpm for hydrogen; the working pressure for each kind of gas being within a range from 4 to 6 kg/cm²; the spray power: 42 to 48 kw (current: 396 to 457 A, voltage: 105 to 106V); the spray distance: 8 to 10 cm; the scanning rate of the spray gun: 800 to 1200 mm/sec; the powder feeding rate: 2 to 6 g/min; and pre-heating temperature of substrate for film deposition: 750 to 900° C.

### Example 4: the gas-tight electrolyte layer comprising lanthanum strontium gallate magnesite (LSGM)

The powder clusters to be injected into the plasma flame are formed by agglomeration or by sintering and crushing and are categorized into the group for sizes between 20 to 40 μm. The powder clusters formed by agglomeration are micron powder clusters formed of nano lanthanum strontium gallate magnesite (LSGM) powders and a polyvinyl alcohol (PVA) binder, or micron powder clusters formed of lanthanum strontium gallate magnesite (LSGM) powders of 0.2 to 2 μm in size and a PVA binder. The powder clusters formed by sintering and crushing are composed of nano LSGM powders (or grains) or LSGM powders (or grains) of 0.2 to 2 μm in size. The powders clusters are internally injected upward (FIG. 5B). The plasma spray parameters include: the plasma gas flow rate: 49 to 60 slpm for spray power: 49 to 52 kw (current: 462 to 495 A, voltage: 105 to 106V); the spray distance: 8 to 10 cm; the scanning rate of the spray gun: 500 to 700 mm/sec; the powder feeding rate: 2 to 6 g/min; and pre-heating temperature of substrate for LSGM film deposition: 750 to 900° C.

### Example 5: the porous nano structured cathode interlayer comprising a graded mixture (LSGM/LSCF) of lanthanum strontium gallate magnesite and lanthanum strontium cobalt ferrite

There are two types of powder clusters injected into the plasma flame. One is micron powder clusters formed of nano or sub-micron lanthanum strontium gallate magnesite (LSGM) powders and a polyvinyl alcohol (PVA) binder, while the other is micron powder clusters formed of sub-micron lanthanum strontium cobalt ferrite (LSCF) powders and a polyvinyl alcohol (PVA) binder. The powder clusters are categorized into the group for sizes between 20 to 40 μm. These two types of powder clusters are transmitted by a dual-hopper powder feeder (such as Sulzer Metco Twin-120) to a Y-hybrid powder mixer connected to a plasma spray gun. The powders are externally injected downward (FIG. 5C).

Moreover, the plasma spray parameters include: the plasma gas flow rate: 49 to 60 slpm for argon, 23 to 27 slpm for helium, and 2 to 5 slpm for hydrogen; the spray power: 28 to 38 kw (current: 302 to 432 A, voltage: 88 to 93V); the spray distance: 9 to 11 cm; the scanning rate of the spray gun: 500 to 700 mm/sec; the powder feeding rate: 2 to 8 g/min; and pre-heating temperature of substrate for film deposition: 650 to 750° C.

The cathode interlayer can be gradedly coated and the ratio between nano or sub-micron lanthanum strontium gallate magnesite (LSGM) and sub-micron lanthanum strontium cobalt ferrite (LSCF) changes according to the gradedly volumetric ratio along a normal direction to the surface of this cathode interlayer. In other words, the cathode interlayer contains a higher percentage of LSGM as it gets closer to the electrolyte layer. Moreover, if the cathode interlayer is not to be formed as gradedly structured, a layer of a mixture (LSGM/LSCF) of lanthanum strontium gallate magnesite (LSGM) and lanthanum strontium cobalt ferrite (LSCF) with 50%:50% volumetric ratio of LSGM:LSCF is formed by spraying micron powder clusters formed of nano or sub-micron lanthanum strontium gallate magnesite (LSGM) powders, sub-micron lanthanum strontium cobalt ferrite (LSCF) powders and a polyvinyl alcohol (PVA) binder.

### Example 6: the porous cathode current collecting layer comprising lanthanum strontium cobalt ferrite (LSCF)

The powder clusters to be injected into the plasma flame are formed by agglomeration and are categorized into the group for sizes between 40 to 70 μm. The powder clusters are micron powder clusters formed of sub-micron or micron lanthanum strontium cobalt ferrite (LSCF) powders and a polyvinyl alcohol (PVA) binder. The powders are externally injected downward (FIG. 5C). The plasma spray parameters include: the plasma gas flow rate: 49 to 60 slpm for argon, 23 to 27 slpm for helium, and 2 to 5 slpm for hydrogen; the spray power: 28 to 38 kw (current: 302 to 432 A, voltage: 88 to 93V); the spray distance: 9 to 11 cm; the scanning rate of the spray gun: 500 to 700 mm/sec; the powder feeding rate: 2 to 8 g/min; and pre-heating temperature of substrate for film deposition: 650 to 750° C.

### Example 7: the Ni-LSCM-LDC/Ni-LDC-LSGM-LSGM/LSCF-LSCF solid oxide fuel cell

According to the spray parameters in the afore-mentioned Examples 1 to 6, the porous first anode isolation layer comprising LSCM, the porous nanostructured anode interlayer comprising a graded mixture (LDC/Ni) of nickel and lanthanum doped ceria (LDC), the second anode isolation layer comprising nano lanthanum doped ceria (LDC), the gas-tight electrolyte layer comprising lanthanum strontium gallate magnesite (LSGM), the porous nano structured cathode interlayer comprising a graded mixture (LSGM/LSCF) of lanthanum strontium gallate magnesite and lanthanum strontium cobalt ferrite are formed in order on the porous metal substrate to completely manufacture a Ni-LSCM-LDC/Ni-LDC-LSGM-LSGM/LSCF-LSCF solid oxide fuel cell. Moreover, if the cathode interlayer is not to be formed as gradedly structured, then the volumetric ratio of LSGM:LSCF is 50%:50% in the mixed LSGM/LSCF cathode interlayer. Then, the solid oxide fuel cell is hot-pressed at a temperature within a range from 875 to 950° C. for 1 to 3 hours to achieve better electric characteristics of the cell.

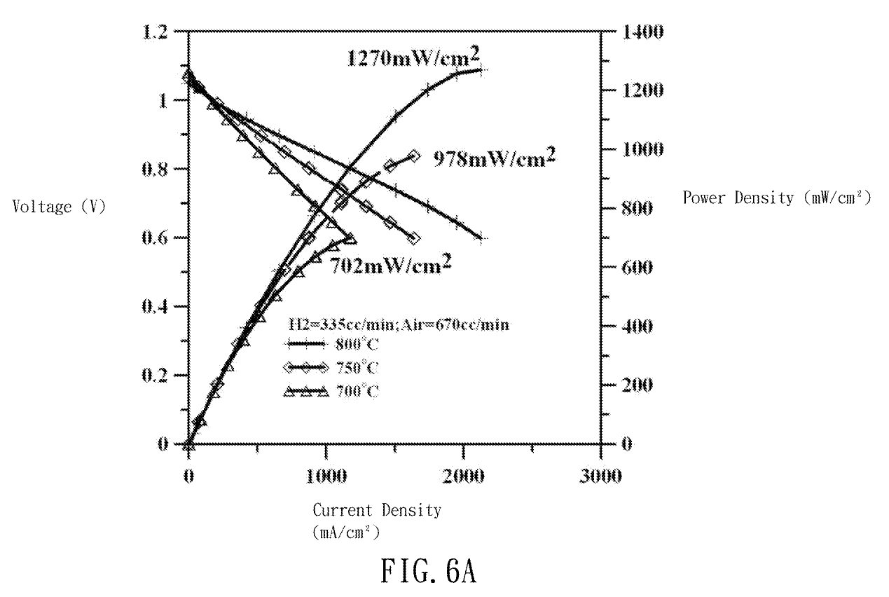

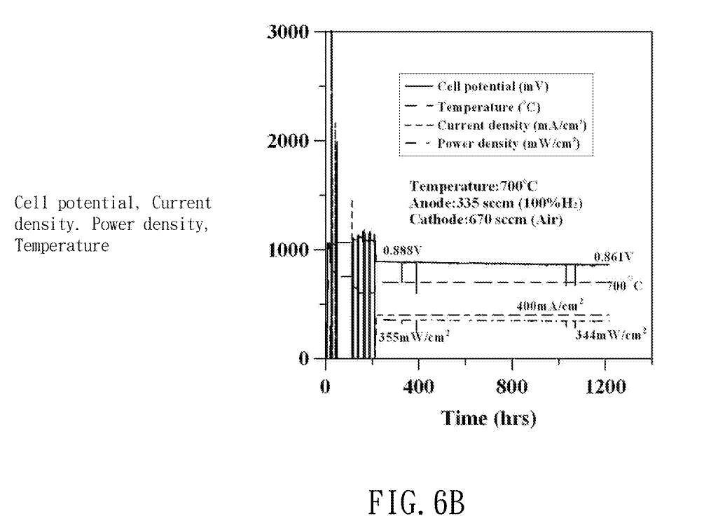

FIG. 6A and 6B show the electric characteristics and the long-term durability test at a constant 400 mA/cm² of a solid oxide fuel cell presented in the example 7 according to the first embodiment of the present invention. The solid oxide fuel cell with a cathode area of 15 cm² exhibits a maximum output power density of 1.2 W/cm² at a working temperature of 800° C. The present invention is not limited to the cathode area as aforementioned.

As stated above, the solid oxide fuel cell and the manufacturing method thereof according to the present invention at least comprise advantages of:

1. The powder clusters are divided into groups according to the size. For example, a group for sizes within a range from 10 to 20 μm, a group for sizes within a range from 20 to 40 μm and a group for sizes within a range from 40 to 70 μm are provided. Since only one group of powder clusters is sprayed by the plasma spray gun at a time, the plasma spray power value for such a group of powder clusters is selected. Therefore, the present invention prevents the larger powder clusters from being unevenly heated or being difficult to become semi-melted and the smaller powder clusters from being decomposed due to overheating.

2. The powder clusters to be injected into the plasma flame may be formed by agglomeration or by sintering and crushing, which increases flexibility in choosing the powder clusters. Cheaper powders with poorer distribution of shapes and diameters can also be used.

3. If the powder clusters are formed by agglomeration, a binder mixed with powders are injected into a plasma flame to burn out the binder and melt the remaining powders that are deposited as a thin film to achieve better uniformity and film quality.

4. In the formation of the porous electrode layers, the sizes of the powders and pores can be controlled to be uniformly or specifically distributed.

5. In the formation of the dense electrolyte layer, the density can be controlled to be uniformly distributed.

6. The acid etching process is capable of removing impurities in the porous metal substrate and enhancing the gas permeability of the porous metal substrate.

7. The nano-structured anode interlayer and the nano-structured cathode interlayer provide a plurality of nano tri-phase boundaries (TPB) to improve the cell electric characteristics while lowering the working temperature of a solid oxide fuel cell.

8. In the present invention, the powders are injected in various ways to control the film characteristics (such as porosity, density or gas-tightness).

9. The plasma flame applied in the medium current and high voltage tri-gas (argon, helium and hydrogen) atmospheric plasma spray process exhibits a longer plasma arc to lengthen the time for heating the powder clusters so that the powders are heated up more efficiently to be deposited to form a thin film with better quality. Since the working current is smaller, the electrode erosion of atmospheric plasma spray gun is reduced and the lifetime of the atmospheric plasma spray gun can be lengthened to reduce cost.

10. The Ni-LSCM-LDC/Ni-LDC-LSGM-LSGM/LSCF-LSCF cells produced by the invented method and processes here have excellent performances of electric output power density and durability.

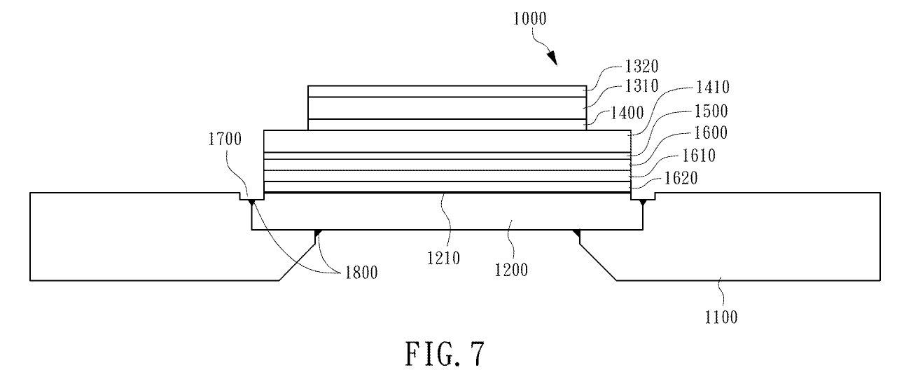

Moreover, on the porous metal substrate of the present invention, the layers in FIG. 1 can be formed in a reverse order to obtain another solid oxide fuel cell 1000. FIG. 7 is a cross-sectional view of a solid oxide fuel cell according to a second embodiment of the present invention. On the porous metal substrate 1200 which comprises of a high temperature anti-oxidation ferritic stainless steel, for instance, the Crofer22, a porous sintered thin powder layer 1210 of the same anti-oxidation ferritic stainless steel material is formed first by the surface powdering process and the hot-press sintering process, and then a medium current and high voltage tri-gas (argon, helium and hydrogen) atmospheric plasma spray process is performed sequentially to deposit an isolation layer 1620 (comprising LSCM), a cathode current collecting layer 1610, a cathode interlayer 1600, a cathode isolation layer 1500, an electrolyte layer 1410, an anode isolation layer 1400, an anode interlayer 1310 and an anode current collecting layer 1320 which comprises of nickel oxide or copper oxide or a nickel-iron oxide mixture or a nickel-iron-cobalt oxide mixture. The solid oxide fuel cell will experience a post treatment and later be combined with a metal frame 1100 by laser welding with welding points 1800 labeled by small points in FIG. 7. Moreover, a groove 1700 can be provided at the joint of the metal frame 1100 and the porous metal substrate 1200 to be filled with a sealant.

In the second embodiment, the manufacturing processes and materials for making the layers are similar to those in the first embodiment and are thus not repeated herein.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A solid oxide fuel cell, comprising:
a metal frame;
a porous metal substrate disposed in the metal frame;
a first anode isolation layer disposed on the porous metal substrate;
an anode interlayer disposed on the first anode isolation layer, the anode interlayer being porous nano structured;
an electrolyte layer disposed on the anode interlayer;
a cathode interlayer disposed on the electrolyte layer; and
a cathode current collecting layer disposed on the cathode interlayer.

2. The solid oxide fuel cell as recited in claim 1, wherein the cathode interlayer comprises a plurality of electron-conducting particles and a plurality of ion-conducting nano particles arranged to form a plurality of cathode pores between the electron-conducting particles and the ion-conducting nano particles, and the cathode pores are nano pores or sub-micron pores.

3. The solid oxide fuel cell as recited in claim 1, wherein the solid oxide fuel cell exhibits a power density higher than 1 Watt/cm².

4. The solid oxide fuel cell as recited in claim 1, wherein the anode interlayer comprises a plurality of electron-conducting nano particles and a plurality of oxygen-negative-ion-conducting nano particles arranged to form a plurality of anode nano pores between the electron-conducting nano particles and the oxygen-negative-ion-conducting nano particles.

5. The solid oxide fuel cell as recited in claim 4, wherein the electron-conducting nano particles comprise nano nickel, nano copper, nano nickel-copper or nano nickel-copper-cobalt, and the oxygen-negative-ion-conducting nano particles comprise nano yttria-stabilized zirconia (YSZ), nano lanthanum doped ceria (LDC) or nano gadolinium doped ceria (GDC).

6. The solid oxide fuel cell as recited in claim 4, wherein the anode interlayer comprises a mixture composed of nano nickel and nano yttria-stabilized zirconia (YSZ/Ni), a mixture composed of nano nickel and nano lanthanum doped ceria (LDC/Ni) or a mixture composed of nano nickel and nano gadolinium doped ceria (GDC/Ni).

7. The solid oxide fuel cell as recited in claim 2, wherein the electron-conducting particles comprise lanthanum strontium cobalt ferrite (LSCF), and the ion-conducting nano particles comprise nano lanthanum strontium gallate magnesite (LSGM), nano gadolinium doped ceria (GDC) or nano lanthanum doped ceria (LDC).

8. The solid oxide fuel cell as recited in claim 7, wherein the cathode interlayer comprises a mixture composed of lanthanum strontium gallate magnesite and lanthanum strontium cobalt ferrite (LSGM/LSCF), a mixture composed of gadolinium doped ceria and lanthanum strontium cobalt ferrite (GDC/LSCF) or a mixture composed of lanthanum doped ceria (LDC) and lanthanum strontium cobalt ferrite (LDC/LSCF).

9. The solid oxide fuel cell as recited in claim 1, wherein the anode interlayer has a plurality of nano tri-phase boundaries (TPB) and the thickness of the anode interlayer is within a range from 10 to 30 μm.

10. The solid oxide fuel cell as recited in claim 9, wherein the thickness of the anode interlayer is within a range from 15 to 25 μm and the porosity of the anode interlayer is within a range from 15 to 30%.

11. The solid oxide fuel cell as recited in claim 1, wherein the cathode interlayer has a plurality of nano tri-phase boundaries (TPB) and the thickness of the cathode interlayer is within a range from 10 to 40 μm.

12. The solid oxide fuel cell as recited in claim 11, wherein the thickness of the cathode interlayer is within a range from 20 to 30 μm and the porosity of the cathode interlayer is within a range from 15 to 30%.

13. The solid oxide fuel cell as recited in claim 4, wherein the anode interlayer contains a higher percentage of electron-conducting nano particles in the portion being closer to the porous metal substrate.

14. The solid oxide fuel cell as recited in claim 2, wherein the cathode interlayer contains a higher percentage of ion-conducting nano particles in the portion being closer to the electrolyte layer.

15. The solid oxide fuel cell as recited in claim 1, wherein the porous metal substrate comprises nickel powders, nickel powders mixed with iron powders, copper powders mixed with iron powders or copper powders and nickel powders mixed with iron powders with the weight percentage of the iron powders being not more than 50%.

16. The solid oxide fuel cell as recited in claim 1, wherein the porosity of the porous metal substrate is within a range from 35 to 55%, and the thickness of the porous metal substrate is within a range from 1 to 2 mm.

17. The solid oxide fuel cell as recited in claim 1, further comprises a porous sintered thin powder layer disposed between the porous metal substrate and the first anode isolation layer.

18. The solid oxide fuel cell as recited in claim 17, wherein the diameters of surface pores of the porous sintered thin powder layer are smaller than 50 μm.

19. The solid oxide fuel cell as recited in claim 17, wherein the porous sintered thin powder layer and the porous metal substrate comprise the same material.

20. The solid oxide fuel cell as recited in claim 17, wherein the porous sintered thin powder layer is thinner than 40 μm.

21. The solid oxide fuel cell as recited in claim 17, wherein the porosity of the porous metal substrate is within a rage from 35 to 55% and the gas permeability coefficient is within a range from 2 to 6 Darcy.

22. The solid oxide fuel cell as recited in claim 1, wherein the metal frame comprises ferritic stainless steel.

23. The solid oxide fuel cell as recited in claim 1, wherein the metal frame comprises Crofer22.

24. The solid oxide fuel cell as recited in claim 1, wherein the metal frame exhibits a thermal expansion coefficient within a range from 10 to 14×10⁻⁶/° C.

25. The solid oxide fuel cell as recited in claim 1, further comprising a protection layer disposed on the metal frame, the protection layer comprising manganese-cobalt spinel or lanthanum strontium-doped manganite (LSM).

26. The solid oxide fuel cell as recited in claim 1, wherein the electrolyte layer comprises lanthanum strontium gallate magnesite (LSGM), lanthanum doped ceria (LDC) or gadolinium doped ceria (GDC).

27. The solid oxide fuel cell as recited in claim 26, wherein the thickness of lanthanum doped ceria (LDC) and gadolinium doped ceria (GDC) is within a range from 10 to 20 μm, and the thickness of lanthanum strontium gallate magnesite (LSGM) is within a range from 30 to 45 μm.

28. The solid oxide fuel cell as recited in claim 1, wherein the cathode current collecting layer is porous sub-micron structured or porous micron structured.

29. The solid oxide fuel cell as recited in claim 1, wherein the cathode current collecting layer comprises lanthanum strontium cobalt ferrite (LSCF), lanthanum strontium cobaltite (LSCo) or lanthanum strontium ferrite (LSF).

30. The solid oxide fuel cell as recited in claim 1, wherein the thickness of the cathode current collecting layer is within a range from 20 to 50 μm, and the porosity of the cathode current collecting layer is within a range from 30 to 50%.

31. The solid oxide fuel cell as recited in claim 1, further comprising a cathode isolation layer disposed between the electrolyte layer and the cathode interlayer.

32. The solid oxide fuel cell as recited in claim 31, wherein the cathode isolation layer comprises lanthanum doped ceria (LDC), yttria doped ceria (YDC) or gadolinium doped ceria (GDC).

33. The solid oxide fuel cell as recited in claim 31, wherein the thickness of the cathode isolation layer is within a range from 5 to 15 μm.

34. The solid oxide fuel cell as recited in claim 1, wherein the first anode isolation layer comprises lanthanum doped ceria (LDC), lanthanum strontium manganese chromite (La_{0.75}Sr_{0.25}Cr_{0.5}Mn_{0.5}O₃, LSCM) chromic oxide or other materials having capabilities to conduct electrons and prohibit chromium diffusion.

35. The solid oxide fuel cell as recited in claim 1, wherein the thickness of the first anode isolation layer is within a range from 10 to 20 μm, and the porosity of the first anode isolation layer is within a range from 15 to 30%.

36. The solid oxide fuel cell as recited in claim 1, further comprising a second anode isolation layer disposed between the anode interlayer and the electrolyte layer.

37. The solid oxide fuel cell as recited in claim 36, wherein the second anode isolation layer comprises lanthanum doped ceria (LDC), yttria doped ceria (YDC) or gadolinium doped ceria (GDC).

38. The solid oxide fuel cell as recited in claim 36, wherein the thickness of the second anode isolation layer is within a range from 5 to 15 μm.

39. A solid oxide fuel cell, comprising:
a metal frame;
a porous metal substrate disposed in the metal frame;
a cathode current collecting and isolation layer disposed on the porous metal substrate;
a cathode current collecting layer disposed on the cathode current collecting and isolation layer;
a cathode interlayer disposed on the cathode current collecting layer;
an electrolyte layer disposed on the cathode interlayer;
an anode interlayer disposed on the electrolyte layer, the anode interlayer being porous nano structured; and
an anode current collecting layer disposed on the anode interlayer.

40. The solid oxide fuel cell as recited in claim 39, wherein the cathode interlayer comprises a plurality of electron-conducting particles and a plurality of ion-conducting nano particles arranged to form a plurality of cathode pores between the electron-conducting particles and the ion-conducting nano particles, and the cathode pores are nano pores or sub-micron pores.

41. The solid oxide fuel cell as recited in claim 39, further comprises a porous sintered thin powder layer disposed between the porous metal substrate and the cathode current collecting and isolation layer.

42. The solid oxide fuel cell as recited in claim 39, further comprising a cathode isolation layer disposed between the electrolyte layer and the cathode interlayer.

43. The solid oxide fuel cell as recited in claim 39, further comprising an anode isolation layer disposed between the anode interlayer and the electrolyte layer.

44. The solid oxide fuel cell as recited in claim 39, further comprising a protection layer disposed on the metal frame, the protection layer comprising manganese-cobalt spinel or lanthanum strontium-doped manganite (LSM).

45. A manufacturing method of a solid oxide fuel cell comprising a plurality of layers, the method comprising steps of:
preparing a plurality of powder clusters with pre-determined size that are to be used by a plasma spray gun, the powder clusters being made of materials that are used to manufacture the layers;
dividing the powder clusters into a plurality of groups according to the size of the powder clusters;
depositing a first anode isolation layer, an anode interlayer, an electrolyte layer, a cathode interlayer and a cathode current collecting layer sequentially on a porous metal substrate by atmospheric plasma spray;
wherein the plasma spray gun operates at pre-determined power values according to the groups.

46. The manufacturing method of a solid oxide fuel cell as recited in claim 45, wherein the powder clusters are divided into a group for size within a range from 10 to 20 μm, a group for size within a range from 20 to 40 μm and a group for size within a range from 40 to 70 μm.

47. The manufacturing method of a solid oxide fuel cell as recited in claim 45, wherein at least one of the layers is manufactured by a tri-gas atmospheric plasma spray process.

48. The manufacturing method of a solid oxide fuel cell as recited in claim 45, further comprising a preliminary treatment on the porous metal substrate, the preliminary treatment comprising steps of:
providing the porous metal substrate;
performing an acid pickling process on the porous metal substrate;
performing a surface powdering process on the porous metal substrate; and
performing a hot pressing process on the porous metal substrate to achieve high-temperature sintering and flattening

49. The manufacturing method of a solid oxide fuel cell as recited in claim 48, wherein the surface powdering process is to coat the porous metal substrate with metal powder slurry within a region enclosed by a dense frame and then flatten the metal powder slurry.

50. The manufacturing method of a solid oxide fuel cell as recited in claim 49, wherein the metal powder slurry comprises nickel powders or a mixture of nickel, iron, copper and cobalt.

51. The manufacturing method of a solid oxide fuel cell as recited in claim 48, wherein the hot pressing process is to perform hot pressing at a temperature below 1100° C. in a vacuum or a reducing atmosphere and under a pressure below 50 kg/cm² for 1 to 3 hours and then cool down to room temperature.

52. The manufacturing method of a solid oxide fuel cell as recited in claim 48, further comprising a step of performing an acid etching process on the porous metal substrate after the hot pressing process.

53. The manufacturing method of a solid oxide fuel cell as recited in claim 52, further comprising a step of performing a low-temperature surface oxidation process on the porous metal substrate after the acid etching process.

54. The manufacturing method of a solid oxide fuel cell as recited in claim 53, wherein the surface oxidation process is to perform surface oxidation at a temperature within a range from 600 to 700° C. for 20 to 50 minutes.

55. The manufacturing method of a solid oxide fuel cell as recited in claim 45, further comprising a step of performing a post treatment after the cathode current collecting layer is deposited.

56. The manufacturing method of a solid oxide fuel cell as recited in claim 55, wherein the post treatment is a hot-pressing treatment at a temperature within a range from 875 to 950° C. under a pressure within a range from 200 g to 1 kg/cm².

57. The manufacturing method of a solid oxide fuel cell as recited in claim 55, further comprising a step of combining the porous metal substrate and a metal frame after the post treatment.

58. The manufacturing method of a solid oxide fuel cell as recited in claim 45, wherein further comprising of forming a second anode isolation layer between the anode interlayer and the electrolyte layer.

59. The manufacturing method of a solid oxide fuel cell as recited in claim 45, wherein further comprising of forming a cathode isolation layer between the cathode interlayer and the electrolyte layer.

60. The manufacturing method of a solid oxide fuel cell as recited in claim 47, wherein the tri-gas atmospheric plasma spray process uses a mixture of argon, helium and hydrogen.

61. The manufacturing method of a solid oxide fuel cell as recited in claim 45, wherein the powder clusters are formed to be micron powder clusters by aggregating nano powders of materials that are used to manufacture the layers with a polyvinyl alcohol (PVA) binder.

62. The manufacturing method of a solid oxide fuel cell as recited in claim 45, wherein the powder clusters are formed to be micron powder clusters by sintering nano powders of materials that are used to manufacture the layers and crushing the sintered materials.

63. The manufacturing method of a solid oxide fuel cell as recited in claim 57, further comprising a step of filling a groove with a sealant after combining the porous metal substrate and the metal frame, the groove being formed by combining the porous metal substrate and the metal frame.
